(19) United States
(12) Patent Application Publication
(10) Pub. No.: US 2025/0384734 A1
(43) Pub. Date: Dec. 18, 2025

(54) Game Detection Using an AI Engine

(71) Applicant: Aristocrat Technologies, Inc., Las Vegas, NV (US)

(72) Inventors: Upinder Dhaliwal, Las Vegas, NV (US); Eric Droukas, Las Vegas, NV (US); Chan Ho Park, Hong Kong (CN); Kwan Chi Chow, Hong Kong (CN); Chin Sen Leung, Hong Kong (CN)

(21) Appl. No.: 18/745,521

(22) Filed: Jun. 17, 2024

(51) Int. Cl. G07F 17/32; G07F 17/34

(52) U.S. Cl. CPC G07F 17/3227; G07F 17/3211; G07F 17/3216; G07F 17/34

(57) ABSTRACT

A technique for automatic game identification is describe. The technique includes capturing image data of an environment, identifying a cabinet region, and determining a cabinet type from the image data of the cabinet region. Content presented by the cabinet is detected and analyzed to identify a game based on symbols in the content. A check is performed to ensure the game is available on the cabinet type. Additional information for the identified game is obtained and presented to a user. The cabinet type is identified by a cabinet detection engine, and the game is identified by a game detection model.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome, and symbols are then selected which correspond to that outcome. Notably, some games may include an element of skill on the part of the player and are therefore not entirely random.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 illustrates a flowchart of a technique for identifying a game using an artificial intelligence engine, in accordance with one or more embodiments.

FIG. 5 depicts an example of an image capture process of a gaming environment, in accordance with one or more embodiments.

FIG. 6 depicts an example diagram for identifying cabinets in image data, in accordance with one or more embodiments.

FIG. 7 depicts an example user interface for game selection, in accordance with one or more embodiments.

FIG. 8 depicts an example user interface for presenting game information for a selected game, and according to the more embodiments.

FIG. 9 illustrates a flowchart of an example technique for detecting cabinets in image data, in accordance with one or more embodiments.

FIG. 10 depicts a flowchart of an example technique for identifying a game from image data, in accordance with one or more embodiments.

FIG. 11 depicts a system diagram for a client device configurable to identify games in a physical environment, in accordance with a more embodiments.

### DETAILED DESCRIPTION

Embodiments herein describe an artificial intelligence (AI) engine that can identify games on a casino floor. Specifically, the AI engine utilizes a cabinet detection model and a game detection model to identify a game. The AI engine first detects the cabinet displaying the game and once the AI engine identifies the cabinet, the AI engine then utilizes the game detection model to identify the game.

Today's casino properties are attempting to deliver experiences that a player will value and generate loyalty. By doing so, casino's attempt to incentivize a player to continue his/her gaming activity at a specific casino or casino brand. One of these experiences that could provide loyalty value is having players understand and become familiar with games on the floor. A player may in some instances simply walk by a game in a casino without ever realizing that the game may suit his or her preferences. Players may also avoid playing new games given the player's lack of familiarity or perception that the game may not be lucky. To address these concerns, embodiments described herein educate the player about new game releases and provide game recommendations to players in real time. To enhance the player's experience, the techniques described herein dynamically recognize a game a player is interested in on the casino floor in real-time. A player app can then provide real-time information, demos, and/or recommendations.

According to one or more embodiments, automatic game detection is described herein by using camera input from a user's device to identify the type and location of the cabinets in a gaming environment, such as a casino floor. The technique includes using a cabinet detection engine that predicts the shape, size, and angle of the cabinet and compares it with a catalog of known cabinets. The engine also filters out false positives based on certain criteria, such as detection probability. A game detection model is then used, which is configured to identify content presented by the cabinet, such as reels and symbols, and predicts a current game based on the identified content. In some embodiments, the technique includes obtaining information related to the identified game, for example from a content management system, and providing a user interface with the information about the game.

Embodiments described herein provide a technical solution for providing information about electronic gaming devices by utilizing a cabinet detection model in conjunction with a game detection model to efficiently predict a game in a user's environment. The models are trained on schematics such as CAD drawings or other data indicative of physical characteristics of gaming cabinets, and is trained to predict the cabinet type based on predicted size as compared to the known properties of cabinets. The game detection model takes advantage of game information indicating cabinet types on which the game is available to reduce the complexity of the game prediction. Thus, techniques provided herein improve efficiency of game detection such that the detection can be performed by a mobile device.

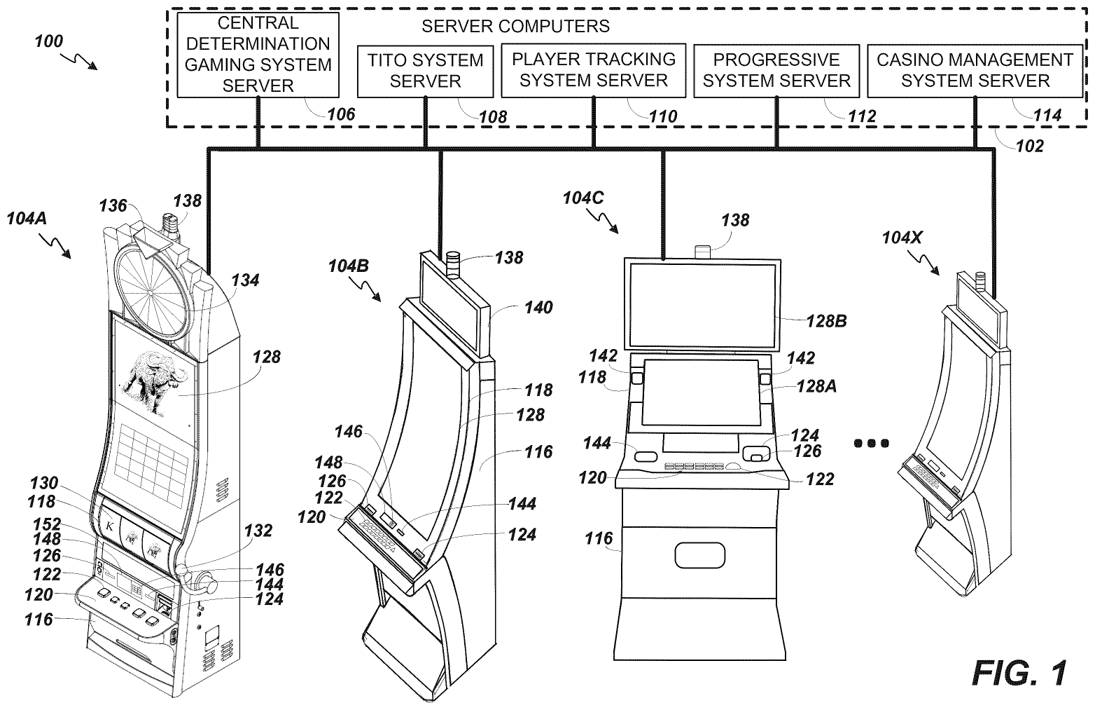

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system (CMS) 114, which may include one or more servers. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

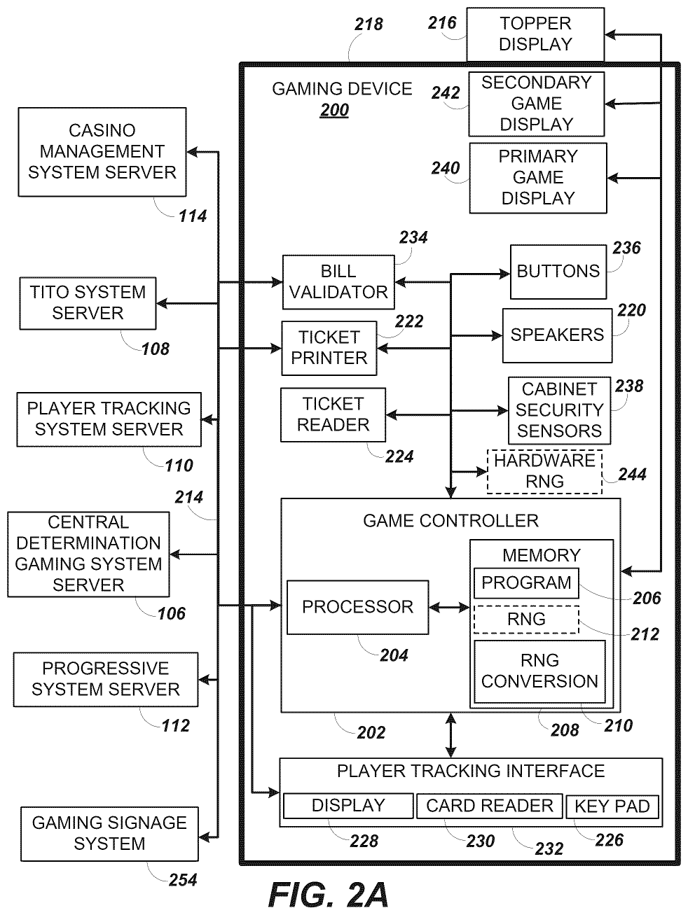

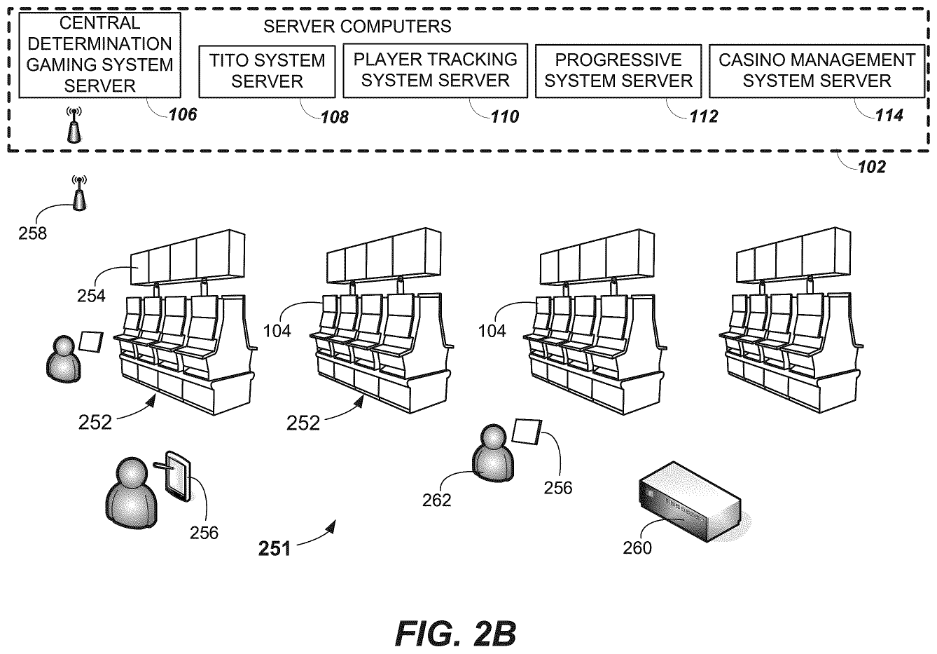

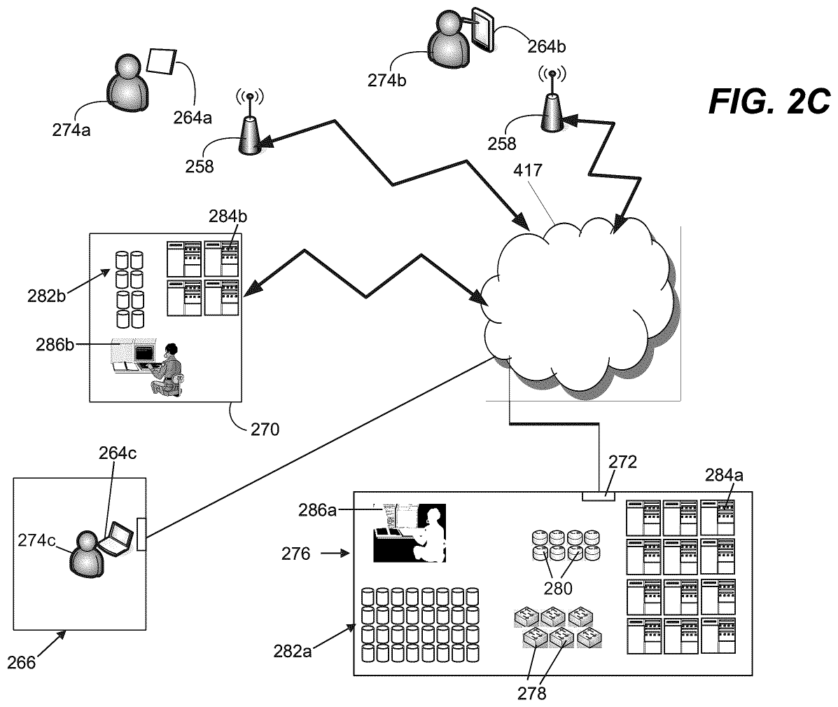

Many or all of the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play, or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random-access memory (DRAM), magnetic random-access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system (CMS).

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

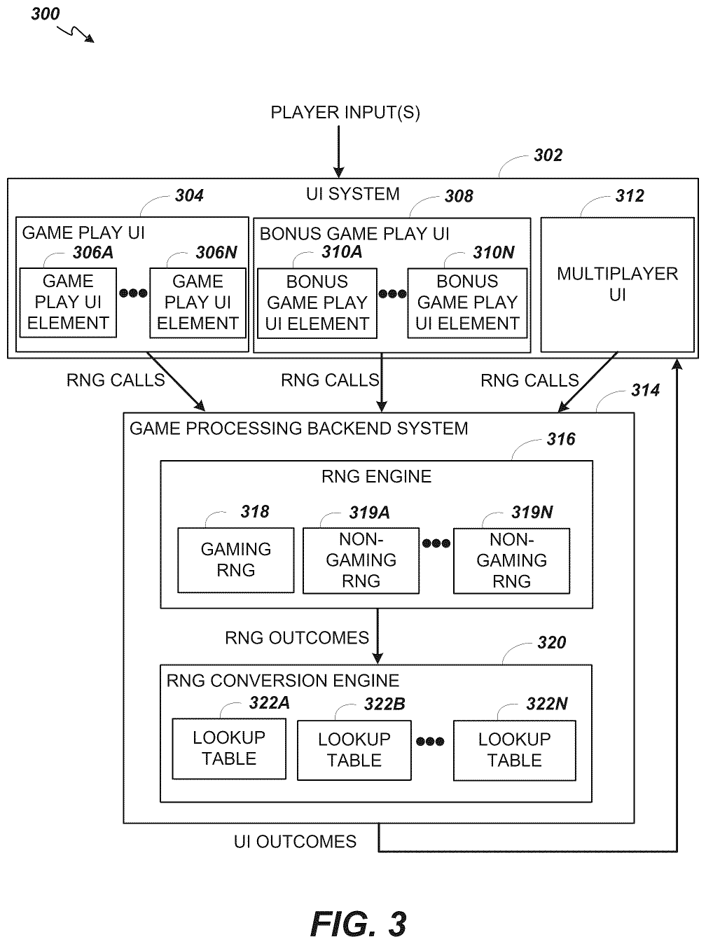

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

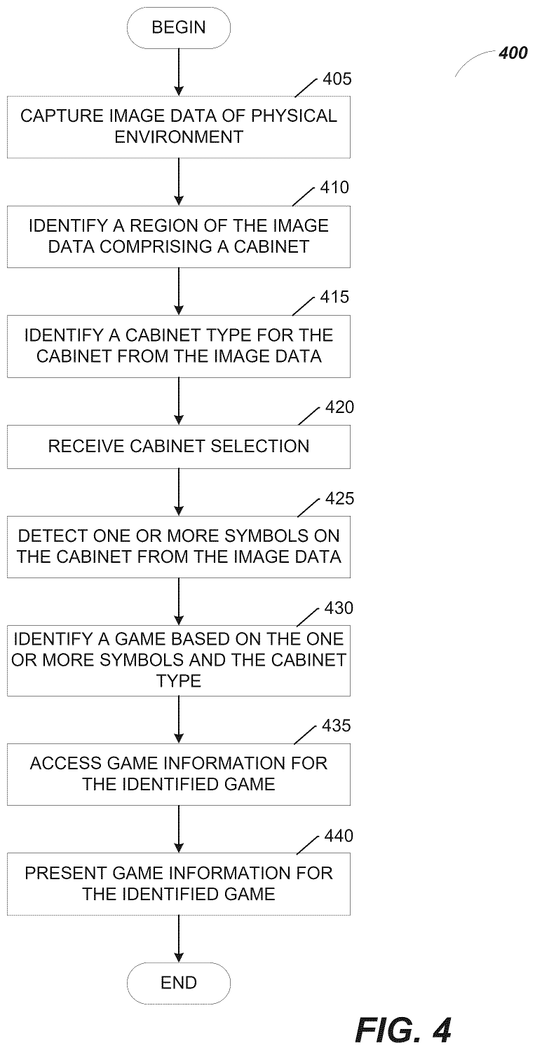

FIG. 4 illustrates a flowchart of a technique for identifying a game using an artificial intelligence engine, in accordance with one or more embodiments. Although the flowchart depicts various actions and processes performed in a particular order, it should be understood that in some embodiments, the actions and processes may be performed in a different order. Further, in some embodiments, some or all of the actions may be performed concurrently. In addition, in some embodiments not all processes or actions may be necessary to complete the tasks described, or additional processes or actions may be needed. In addition, the various steps are described as being performed by particular components, for example among a client device, a CMS, and an EGM. However, the components performing the steps may differ in accordance with some embodiments.

The flowchart 400 begins at block 405 where a system captures image data of a physical environment. According to one or more embodiments, the system capturing the image data may include an electronic device such as a phone, tablet, wearable device, or the like which includes one or more cameras and has image capture capability. In addition to the image data, additional sensor data may be captured, such as image data, depth data, and the like. For example, cameras, depth sensors, and/or the like can be used to capture sensor data from which characteristics of a physical gaming area can be derived. These characteristics may include, for example, geometric information, texture information, and the like.

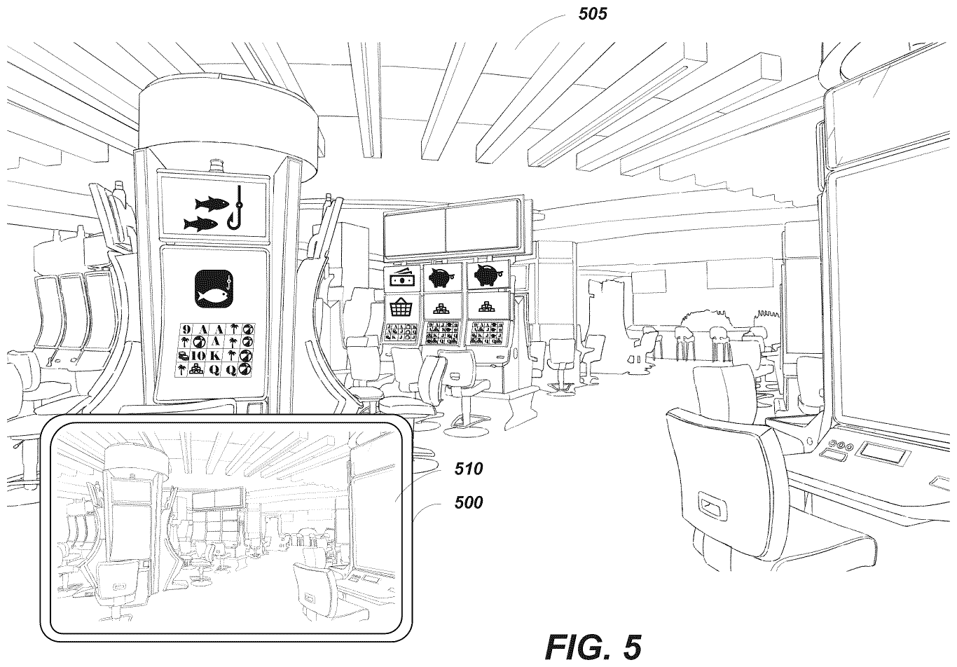

Referring to FIG. 5, an example is depicted image capture process of a gaming environment, in accordance with one or more embodiments. The system 500 may be configured to capture image data 510 of a physical environment 505. Here, the system 500 is a mobile device on a casino floor and capturing image data 510 of a particular portion of the casino floor having a variety of cabinets showing different games. To facilitate identification of different cabinets, the system 500 may include one or more cameras, one or more depth sensors, and the like.

Returning to FIG. 4, the flowchart 400 proceeds to block 410, where a region of the image comprising a cabinet is identified. In some embodiments, multiple cabinet regions may be identified in the image data. The cabinet regions may be identified, for example, using object detection techniques which predict portions of the image data which include a cabinet based on known characteristics of cabinets. For example, the model may ingest the image data and generate one or more bounding boxes indication geometric regions of the image which are predicted to include a cabinet.

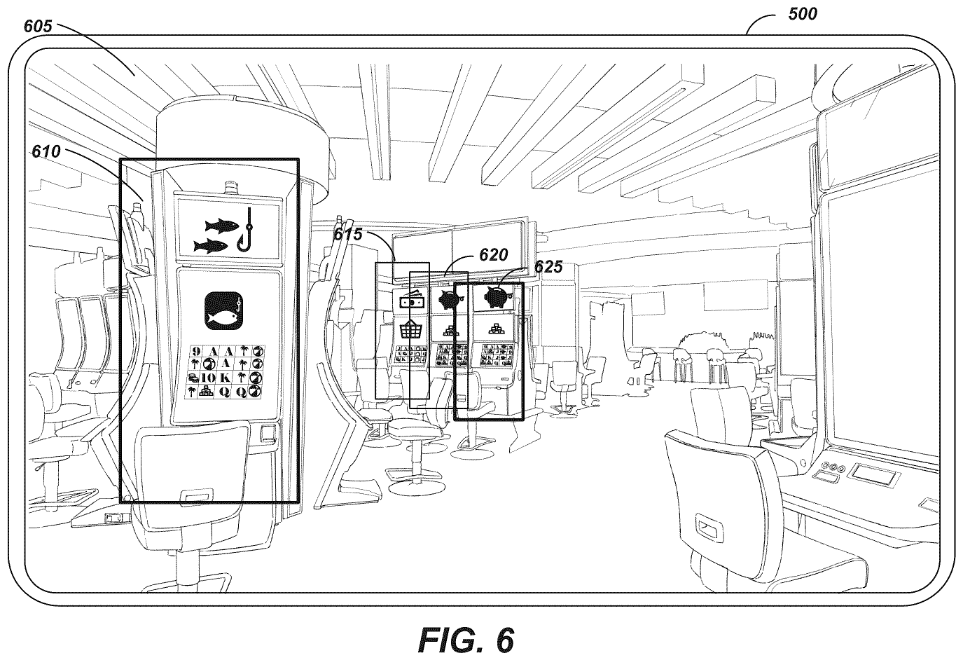

Turning to FIG. 6, an example view is shown on the display of system 500, showing example identified bounding boxes. It should be understood that in some embodiments, the system 500 may identify the bounding boxes in the image data without presenting the bounding boxes on a display. In this example, the view 605 of the gaming area shows four example bounding boxes which may be identified based on cabinet shapes identified in the view. In particular, a first region 610 shows a cabinet facing the camera of the device. A second cabinet region 615, third cabinet region 620, and fourth cabinet region 625 show bounding boxes in the image data corresponding to three cabinets which are part of a single bank of cabinets, and are captured by the camera at an angle.

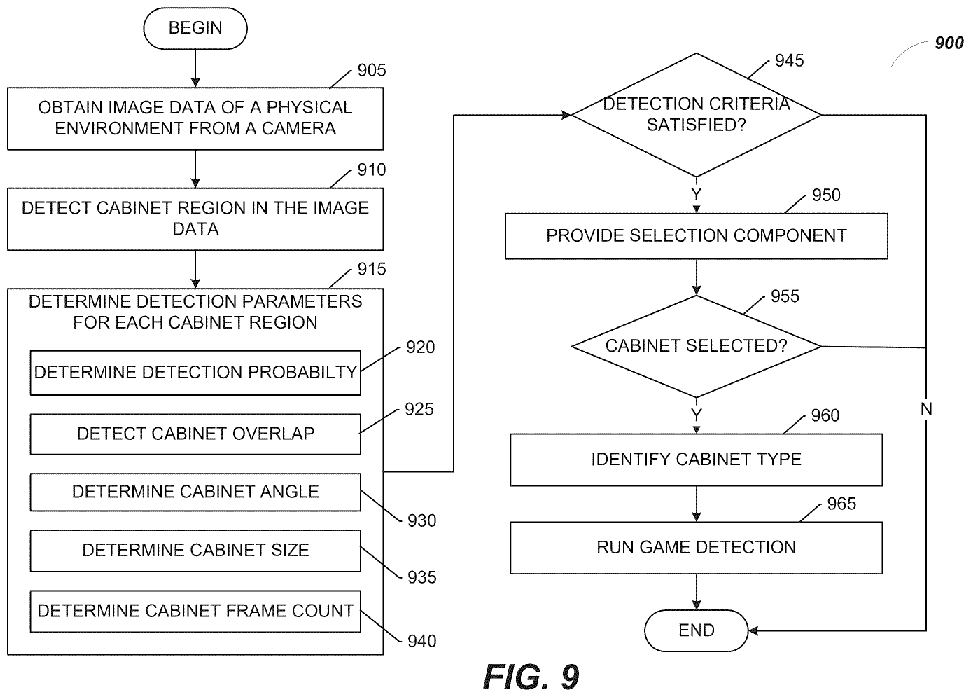

Returning to FIG. 4, at block 415, the technique includes identifying a cabinet type for the cabinet region from the image data. In some embodiments, a same or different model may take the bounding boxes or other image regions identified at block 410 and predict a cabinet type in the particular region based on the specifications of known cabinets. For example, the model may be trained on CAD drawings or other specifications of gaming cabinets. The model may be configured to predict characteristics of the cabinet in the image region, such as shape, size, dimensions, angle, and the like, and find a best match among the known cabinets. According to one or more embodiments, additional data can be used to facilitate cabinet type identification. For example, a model or layout of the casino floor may be available which maps cabinets on the casino floor. To that end, the identification process may involve using localization to determine a location on the casino floor corresponding to the image data, and using the predefined model or layout of the casino floor to identify one or more cabinets. The process may be performed for each region identified at block 410. In some embodiments, some regions or bounding boxes may be ignored, for example if a likelihood of identification of the cabinet is low based on the image data. The cabinet detection process, including the process for selectively detecting cabinet types, will be described in greater detail below with respect to FIG. 9.

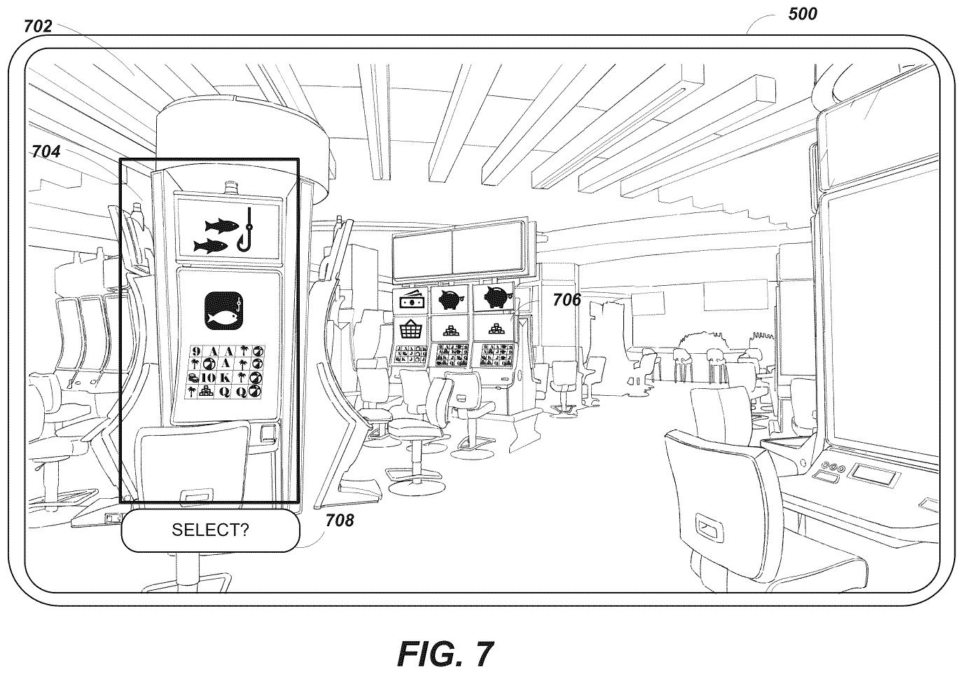

At block 420, a cabinet selection is received. In some embodiments, a selection component may be presented for cabinet regions for which cabinet types are identified. For example, cabinet type selection may spawn a selectable user interface component which, when selected, allows a user to indicate interest in a particular cabinet. Turning to FIG. 7, an example view is shown on the display of system 500, showing a bounding box 704 for which a cabinet type is identified. The user interface 702 additionally includes a selection component 708 presented along with the cabinet 704 for which the cabinet type was determined. In some embodiments, an application on the device 500 may generate the selection component 708 and render the selection component 708 to be presented in the user interface 702 on or near the corresponding cabinet 704.

At block 425, one or more symbols on the cabinet are detected from the image data. In some embodiments, the symbols are detected from cabinets for which a cabinet type can be detected, such that cabinet regions for which a cabinet type is not determined are ignored or discarded. Accordingly, in FIG. 7, the symbols on cabinet 704 are identified, whereas the symbols 706 from the cabinets are ignored.

The flowchart 400 of FIG. 4 proceeds to block 430, where a game is identified based on the one or more symbols. In some embodiments, the detected symbols are analyzed to identify symbols which may be unique to a particular game or game family. For example, in FIG. 7, the symbols in the reel may include common or generic symbols, such as “A, “K,” “Q” and the like, which may be found across multiple families of games. The reel may also show symbols which are specific to the game, such as the palm tree and beach ball. Thus, the non-generic symbols may be compared to known symbols of existing games to identify the particular game on the cabinet.

Returning to FIG. 4, At block 435, game information is accessed for the identified game. The game information may be accessed, for example, from a content management system configured to maintain information about the game, such as image or video data of the game and/or cabinet(s) on which the game is available, game features, game title, game family information, and the like. In some embodiments, the image or video data may be playable at the user device to present a preview of the game being played on a cabinet. The flowchart 400 concludes at block 440, where the game information for the identified game is presented on a display device.

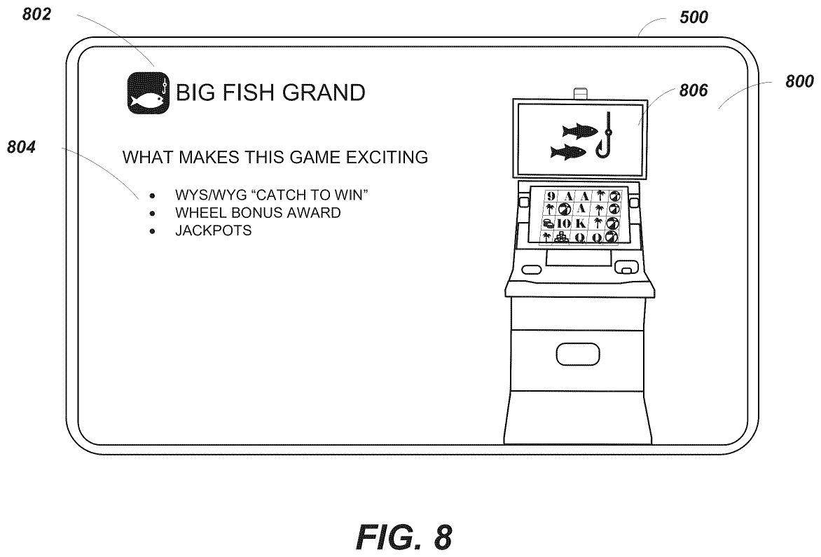

Turning to FIG. 8, an example view is shown on the display of system 500, displaying a user interface 800 for the identified game. In this example, the cabinet is identified by a game title 802 of “Big Fish Grand,” and/or other identifier, such as an iconic image of a fish. The user interface 800 also includes a description region 804, in which a description of unique aspects of the game are described. The user interface 800 also includes an example cabinet 806, which shows a version of the game on a cabinet on which the game is available. In some embodiments, the cabinet region of the interface may include a video which, when initiated, causes a preview of the game play of the identified game. Other information which may be presented include performance data, game family information, game family-specific symbols, game-specific symbols, and the like.

In some embodiments, the technique for identifying a game may include a cabinet detection phase, and a game detection phase. FIG. 9 illustrates a flowchart of an example technique for detecting cabinets in image data, in accordance with one or more embodiments. Although the flowchart depicts various actions and processes performed in a particular order, it should be understood that in some embodiments, the actions and processes may be performed in a different order. Further, in some embodiments, some or all of the actions may be performed concurrently. In addition, in some embodiments not all processes or actions may be necessary to complete the tasks described, or additional processes or actions may be needed. In addition, the various steps are described as being performed by particular components, for example among a client device, a CMS, and an EGM. However, the components performing the steps may differ in accordance with some embodiments.

The flowchart 900 begins at block 905, where image data of a physical environment is obtained by a camera. The image data may be captured of an environment in which one or more electronic gaming machines are present, such as a casino floor or the like. In some embodiments, the system capturing the image data may include an electronic device such as a phone, tablet, wearable device, or the like which includes one or more cameras and has image capture capability. In addition to the image data, additional sensor data may be captured, such as image data, depth data, and the like. For example, cameras, depth sensors, and/or the like can be used to capture sensor data from which characteristics of a physical gaming area can be derived. These characteristics may include, for example, geometric information, texture information, and the like.

The flowchart 900 proceeds to block 910, where a cabinet region is detected in the image data. According to some embodiments, a machine learning model is trained to detect the cabinet region in the image data, such as a cabinet detection model. In some embodiments, the cabinet detection model may be trained using image data of real-world cabinets, and/or synthetic data generated from specifications for pre-existing cabinets, such as from Computer-Aided Design (CAD) files. The synthetic data may simulate different angles, lighting conditions, and cabinet locations in a casino environment. According to one or more embodiments, the cabinet detection model may be pre-trained from cabinet data, and stored on a user's mobile device such that the cabinet detection can be run locally and without accessing additional data from a server or network. The cabinet detection model can then detect physical characteristics of objects in the image data and predict whether the objects are cabinets. The cabinet detection model may identify cabinet regions in the image data surrounding each object detected as a cabinet.

At block 915, detection parameters are determined for each cabinet region. According to one or more embodiments, the detection parameters may correspond to cabinet-related characteristics in the image data. The detection parameters may be used to filter out cabinet regions for which cabinet identification may or is likely to result in a false positive result. The detection parameters are configured to ensure that the model only detects cabinets that are clearly visible and match the expected shape and size. Example detection parameters include, at block 920, determining detection probability. The detection probability may be a value indicative of a confidence in the prediction ability of the model for the particular region. In some embodiments, the detection probability may be a value between 0 and 1, and may correspond to a percentage likelihood that a model can detect a cabinet and/or game in a given cabinet region.

Detection parameters also include, at block 925, detecting cabinet overlap. For example, returning to FIG. 6, cabinet regions 615, 620, and 625 may fail to satisfy some detection parameters because each region is overlapping another region. That is, cabinet regions 615 and 620 are overlapped, and cabinet regions 620 and 625 are overlapped. Other example detection parameters include, at block 930, determining a cabinet angle, and at block 935, determining a cabinet size. The cabinet angle may refer to a relative angle between the camera capturing the image and a front view of the cabinet. The cabinet angle may indicate a likelihood of being able to distinguish or identify symbols presented on a display on the front of the cabinet. In some embodiments, a size of the cabinet in the cabinet region may be predicted and compared against expected sizes of cabinets or other geometric characteristics of known cabinets, such as a ratio between width and height, or the like.

The final example detection parameter is shown at block 940, where a cabinet frame count is determined. The cabinet frame count may indicate a number of frames over which the cabinet region is presented. For example, the cabinet frame count may confirm that the cabinet region is visible over at least a predetermined number of frames. Thus, the cabinet frame count may be a value indicating that the cabinet region is visible for at least a threshold number of consecutive frames, or may indicate how many frames over some window of frames the cabinet region is present.

Although several detection parameters are described, not all detection parameters may be used, or other detection parameters may be added. Further, some detection parameters may be combined. As an example, the detection probability may consider all or part of the other parameters, including cabinet overlap, cabinet angle, cabinet size, and/or cabinet frame count.

The flowchart 900 proceeds to block 945, where determination is made as to whether detection criteria are satisfied. In some embodiments, cabinet regions for which detection parameters are not satisfied are filtered out to avoid false positive determination of cabinets or games, or to reduce resources spent on performing cabinet and/or game detection on regions likely to yield an accurate result. Determining whether detection parameters are satisfied may include comparing one or more of the detection parameters against one or more threshold values or other criteria. Further, in some embodiments, the combination of the various detection parameters may be weighted to determine whether the detection criteria are satisfied.

In some embodiments, the detection probability from block 920 may be compared against a threshold probability value to determine whether detection criteria are satisfied. Said another way, the detection probability may be compared against a threshold confidence value to determine whether the detection criteria is satisfied. Additionally, or alternatively, a cabinet region that is overlapping another cabinet region may be determined to not satisfy the detection criteria. For example, overlapping regions may be discarded because the system may be unable to distinguish which cabinet is presenting the symbols in the overlapping region. Similarly, the cabinet angle may be compared against a threshold angle to ensure that the camera is sufficiently pointed at a front of the cabinet. The predicted size of the cabinet in the cabinet region may be compared against expected sizes of cabinets or other geometric characteristics of known cabinets, such as a ratio between width and height, or the like. In some embodiments, the predicted size of the cabinet may be compared against a predetermined range of sizes, thresholds, or the like to determine whether detection criteria are satisfied. Finally, the cabinet frame count may be compared against a threshold value or other criteria to determine whether the cabinet region is present in a threshold number of consecutive frames.

If at block 945, the detection criteria are determined to not be satisfied, then the flowchart concludes. In some embodiments, the process may begin again at block 905 when new image data is obtained by the system. Further, the system may present a user prompt to navigate the user to capture data more likely to satisfy the detection criteria. As an example, the user may be prompted to move closer to a cabinet, change an angle between the user and the cabinet, or the like.

Returning to block 945, if a determination is made that detection parameters are satisfied, then the flowchart 900 proceeds to block 950, and a selection component is provided. The selection component may be a selectable user interface component which, when selected, indicates user interest in a particular cabinet. Thus, the selection component may be presented adjacent to or over a view of a particular cabinet or cabinet region. For example, the system may be configured to provide a view of the physical environment such as the casino floor on a display using a pass-through image feed. Augmented reality techniques can be used to generate and render the selectable component on the view of the physical environment such that the selectable component is anchored to the particular cabinet or cabinet regions such that as the device moves, the selectable component remains consistently displayed with respect to the cabinet or cabinet region. A determination is made at block 955 as to whether the cabinet is selected. The cabinet may be selected, for example, when user input is received to activate the selectable component from block 950. If the cabinet is not selected, then the flowchart concludes. In some embodiments, the process may begin again at block 905 when new image data is obtained by the system. In some embodiments, the process may begin again at block 905 when new image data is obtained by the system. Further, the system may present a user prompt to navigate the user to capture data more likely to satisfy the detection criteria. As an example, the user may be prompted to move closer to a cabinet, change an angle between the user and the cabinet, or the like.

Returning to block 955, if a determination is made that the cabinet is selected, then the flowchart 900 proceeds to block 960. At block 960, the cabinet type is identified. The cabinet type may refer to a particular cabinet design. In some embodiments, identifying the cabinet type. According to one or more embodiments, the predicted size or other geometric characteristics of the cabinet can be compared against predefined cabinet types to identify the cabinet type in the cabinet region. In some embodiments, a best match may be used to determine the cabinet type. In some embodiments, multiple cabinet types may be identified for a particular cabinet region, such as a predetermined number of top cabinet type matches. Further, in some embodiments, a number of cabinet types identified may be dynamic such that a number of cabinet types returned can be based on a likelihood of a best match as compared to a next best match, or the like.

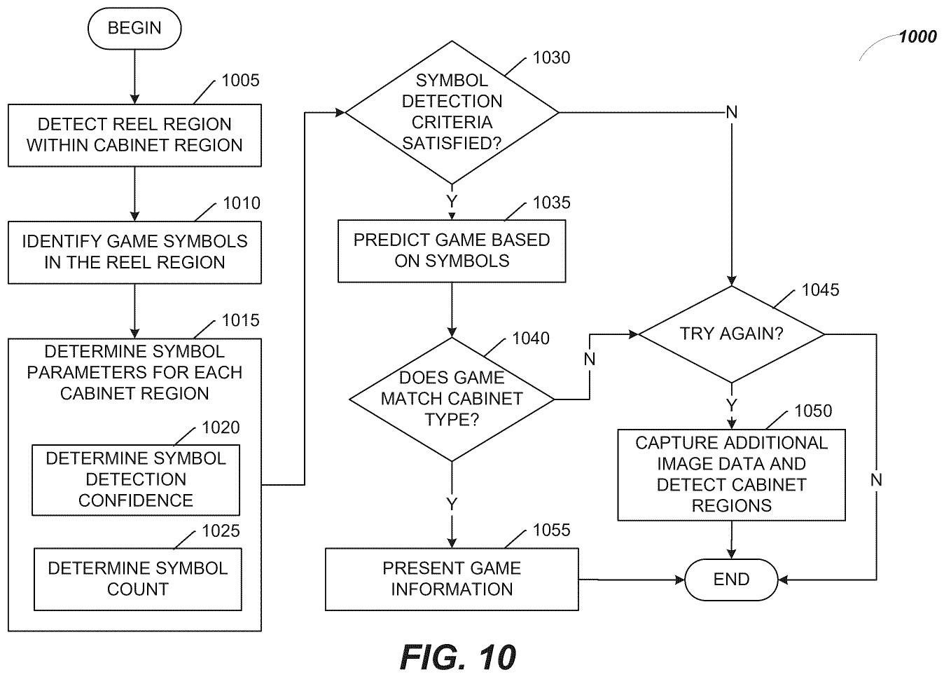

The flowchart 900 concludes at block 965, where game detection is performed. Game detection may be performed in a variety of ways. Generally, a game may be detected based on symbols, images, characters, or other content presented on or by a particular cabinet. An example game detection technique will be described in greater detail below with respect to FIG. 10.

In some embodiments, the various steps may be performed in an alternate order. For example, the cabinet type may be identified at block 960 and/or the game detection may be performed at block 965 for each cabinet region for which the detection criteria is satisfied at block 945. Further, the selection component may be presented for one or more cabinet regions, and selection of the selection component may trigger game detection for the pre-determined cabinet type. As another example, the game may be detected prior to the selection of the cabinet being made such that selection is optional, or alternatively triggers presentation of additional information about the cabinet and/or game.

FIG. 10 depicts a flowchart of an example technique for identifying a game from image data, in accordance with one or more embodiments. Although the flowchart depicts various actions and processes performed in a particular order, it should be understood that in some embodiments, the actions and processes may be performed in a different order. Further, in some embodiments, some or all of the actions may be performed concurrently. In addition, in some embodiments not all processes or actions may be necessary to complete the tasks described, or additional processes or actions may be needed. In addition, the various steps are described as being performed by particular components, for example among a client device, a CMS, and an EGM. However, the components performing the steps may differ in accordance with some embodiments.

The flowchart 1000 begins at block 1005, where the reel region is detected within the cabinet region. For example, a game detection model may be trained to detect a reel layout within the cabinet region image data. In some embodiments, the game detection model may be trained on synthetic data for different games by generating reel templates which have been propagated with game- or family-specific symbols in different configurations. In some embodiments, image data of the reels with the symbols may be warped to reflect the view of the reels on physical EGMs from different camera angles. Thus, the game detection model may identify a reel region in the image data, and at block 1010, may identify game symbols in the reel region. For example, the game detection model can be configured to extract symbols from within the reel region.

The flowchart 1000 continues to block 1015, where symbol parameters are determined for each cabin cabinet region. The symbol parameters may include characteristics about the symbols detected in the image data to determine whether the quality of the symbols is sufficient to identify a game. The simple parameters may include, for example, a symbol detection confidence, which is determined at block 1020. The symbol detection confidence may be a value indicative of a confidence in the prediction ability of the model for the particular region based on the image data of the symbols. In some embodiments, the symbol detection confidence may be a value between 0 and 1, and may correspond to a percentage likelihood that a model can detect symbols in the reel region and/or can accurately detect a game based on the symbols.

The simple parameters may additionally include, determining a symbol count, as shown at block 1025. According to one or more embodiments, the symbol count may be a number of symbols identified in the reel region. In some embodiments, the symbol count may include symbols within a particular frame in which the cabinet region is presented. Alternatively, the symbol count may be based on a number of unique symbols detected in a particular cabinet region over a series of frames. This may occur, for example, if the reels are spinning, or if multiple outcomes are presented within a short period of time.

A determination is made at block 1030 as to whether the symbol criteria are satisfied. In some embodiments, the values for the symbol parameters determined at 1050 may be compared against one or more threshold values or other criteria to determine whether the system is sufficiently likely to be able to detect a game from the symbols. For example, the symbol detection confidence may be compared against a threshold confidence value to determine whether the detection criteria is satisfied. Additionally, or alternatively, the symbol count from block 1025 may be compared against a threshold symbol count or other criteria to determine whether a sufficient number of unique symbols are captured. If the symbol detection criteria are satisfied at block 1030, then the flowchart 1000 proceeds to block 1035, where the game is predicted based on these symbols.

At block 1035, the system compares the symbols to known symbols for different games to determine whether a unique game or family of games can be determined. For example, a matching operation may be performed to determine if symbols are identified that belong to a family of games but not enough symbols are identified so as to detect a unique game, the game family may be identified.

At block 1040, a determination is made as to whether the game matches the cabinet type. For example, a verification operation may be performed to determine whether the game or game family is available on the cabinet type that was detected during the cabinet detection phase. By confirming that the identified game is available on the cabinet type, false positives can be filtered out. Alternatively, in some embodiments, at block 1035, the system may compare the symbols to known symbols only from games available on the cabinet type identified in the cabinet detection phase. Thus, block 1040 may be skipped in some embodiments.

If the game is detected, then the flowchart concludes that block 1055, and game information for the detective game is presented. For example, a user interface may be presented for the unique game or game family and include information about the game or game family for the user. As shown in the example of FIG. 8, identifying information for the game or game family may be presented, along with media related to the game. Other information may include, for example, a description of unique aspects of the game, gameplay information, performance data, family-specific symbols, game-specific symbols, and the like. In some embodiments, the interface may show a graphical representation of a cabinet on which the game is presented, and which may be configured cause a preview of the game play of the identified game. Other information which may be presented include performance data, game family information, family-specific symbols, game-specific symbols, and the like.

Returning to block 1040, if the game does not match the cabinet type, or if at block 1030, symbol parameters are not identified, then the flowchart proceeds to block 1045. A determination is made as to whether the system should try again to identify the game. This may occur automatically, for example after a timeout period or some amount of time. As another example, a selectable component may be presented to the user which, when selected, causes the cabinet detection and/or game detection to be performed with new image data. If the determination is made that the system should try it again, then the flowchart concludes at block 1050, and additional image data is captured and cabinet regions are detected in the additional image data. For example, the process may return to block 410 of FIG. 4, or block 910 of FIG. 9 where the cabinet region is detected.

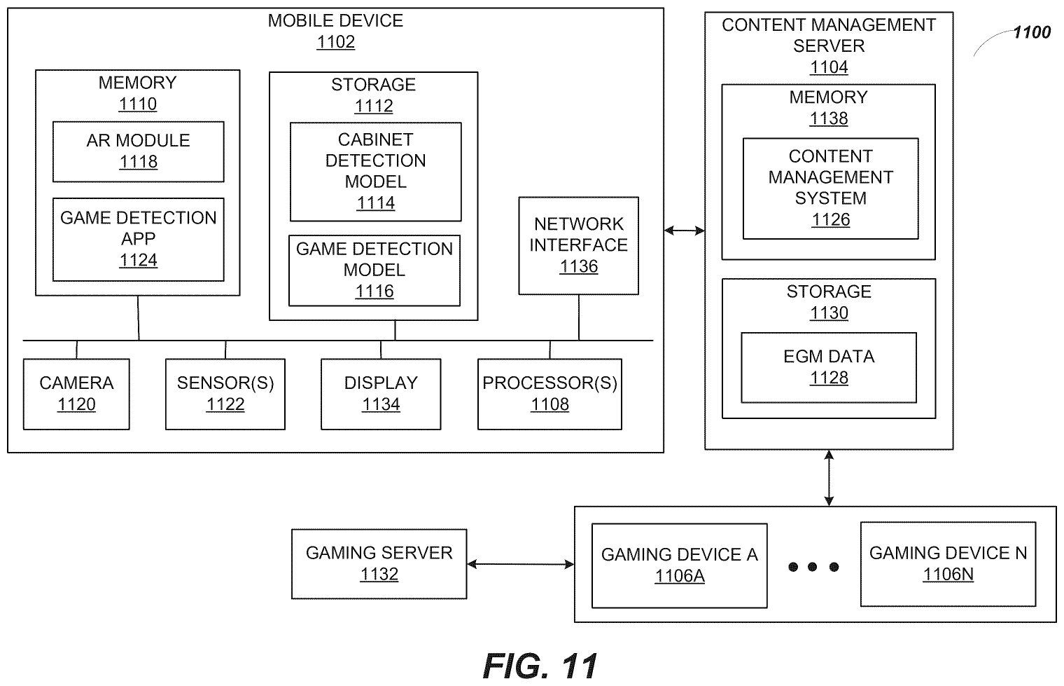

FIG. 11 depicts a network diagram for a client device configurable to detect EGMs and provide information about associated games, in accordance with a more embodiments. The network diagram includes a mobile device 1102, a content management server 1104, and a set of gaming devices, such as gaming devices 1106A-1106N. The mobile device 1102 may be communicably connected to content management server 1104 via a network interface 1136.

The mobile device 1102 may be an electronic device, such as a tablet computer, wearable device, or the like, from which virtual representations of EGMs may be generated and presented. The mobile device includes one or more processors 1108 configured to implement computer code stored, for example, in the memory 1110. Memory 1110 may include, for example, one or transitory or non-transitory computer readable media of one or more different types. Memory 1110 may be configured to host computer readable code executable by the one or more processors 1108. The processor(s) 1108 may include one or more processors, such as one or more central processing units, one or more graphical processing units, or a combination thereof. The mobile device 1102 also includes storage 1112, which may include one or more storage devices configured to store data related to the detection of cabinets and/or games, such as cabinet detection model 1114 and game detection model 1116. In some embodiments, storage 1112 may include EGM data, for example from content management server 1104 which can be used to generate and present content to the user related to identified games.

Memory 1110 may include an augmented reality (AR) module 1118 configured to blend virtual content into a real-world environment. In some embodiments, augmented reality module 1118 may include functionality to identify geometric characteristics of a real-world environment in which the mobile device is situated. For example, the augmented reality module may obtain image data from a camera 1120 and/or other sensor data from sensor(s) 1122 of the mobile device to identify physical characteristics of the real-world environment, such as physical boundaries, planes, lighting, temperature, and the like. As such, sensor(s) may include motion sensors, accelerometers, location sensors such as GPS, gyroscopes, ambient light sensors, LiDAR, depth sensors, and the like. Further, camera may include one or more cameras and may include an image camera, a depth camera, or a combination thereof. The AR module 1118 may therefore perform scans of a physical environment and detect characteristics of objects present in the environment, such as the size and shape of cabinets, symbols and other content presented on or by the cabinet, or the like. The AR module 1118 may be further configured to present interactive components in an augmented reality view. For example, a selection component may be rendered such that it is anchored to a physical object in the environment such as a cabinet or cabinet region as it is presented on display 1134.

Game detection application 1124 may be a programmatic module configured to obtain image data from a physical environment and detect cabinets and/or games using the cabinet detection model 1114 and/or the game detection model 1116, for example by including a cabinet detection engine and/or a game detection engine. In some embodiments, the game detection application 1124 may be configured to provide information about detected games, for example based on gaming information and other data from a content management system 1126 of a content management server 1104. The content management system (CMS) 1126 may be a “headless CMS” provided by memory 1138 of the content management server 1104, and may provide an interface for providing EGM data 1128 from network storage 1130, for example in the content management server 1104, to the mobile device 1102, as well as gaming devices A-N (1106A-1106N). As such, the configurations provided to the user correspond to a game that is implementable on a real-world electronic gaming machine. This is further illustrated by gaming devices A-N (1106A-1106N) being communicably connected to gaming servers 1132 which can be used to generate game outcomes, for example using an RNG.

In some embodiments, the content management server 1104 may train the cabinet detection model 1114 and/or game detection model 1116 based on EGM data 1128. For example, a CAD model of real-world EGMs may be utilized to train the cabinet detection model 1114 and/or game detection model 1116 to detect games from image data. Further, game detection model 1116 may be trained based on family- or game-specific symbols which may be available in the EGM data 1128.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A non-transitory computer readable medium comprising computer readable code executable by one or more processors to:
capture image data of an environment;
identify a cabinet region in the image data;
predict one or more geometric characteristics of a cabinet in the cabinet region from the image data;
determine a cabinet type for the cabinet based on the one or more geometric characteristics and a predefined set of geometric characteristics for a plurality of cabinet types;
detect a reel region in the cabinet region of the image data;
identify one or more game symbols in the reel region;
perform a matching operation in a predefined set of game data to identify a game having the one or more game symbols; and
perform a verification operation to verify that the game is available on the cabinet type.

2. The non-transitory computer readable medium of claim 1, wherein the computer readable code to determine the cabinet type comprises computer readable code to:
apply at least a portion of the image data comprising the cabinet region to a cabinet detection engine.

3. The non-transitory computer readable medium of claim 2, further comprising computer readable code to:
determine that the image data satisfies detection parameters for determining the cabinet type, wherein the detection parameters comprise a plurality of cabinet-related characteristics in the image data; and
apply the at least a portion of the image data comprising the cabinet region to the cabinet detection engine in response to the image data satisfying the detection parameters.

4. The non-transitory computer readable medium of claim 3, wherein the plurality of cabinet-related characteristics are selected from a group consisting of: cabinet angle, cabinet size, and cabinet frame count.

5. The non-transitory computer readable medium of claim 3, wherein the cabinet detection engine comprises a model trained on schematic data for a plurality of gaming cabinets.

6. The non-transitory computer readable medium of claim 1, wherein the matching operation is performed by a game detection model trained to identify the game based on the one or more symbols, and wherein the game detection model is trained to identify at least one selected from a group consisting of game-specific symbols, game family-specific symbols, and common symbols.

7. The non-transitory computer readable medium of claim 1, further comprising computer readable code to:
obtain game information for the identified game; and
present the game information on a display.

8. A method comprising:
capturing image data of an environment;
identifying a cabinet region in the image data;
predicting one or more geometric characteristics of a cabinet in the cabinet region from the image data;
determining a cabinet type for the cabinet based on the one or more geometric characteristics and a predefined set of geometric characteristics for a plurality of cabinet types;
detecting a reel region in the cabinet region of the image data;
identifying one or more game symbols in the reel region;
performing a matching operation in a predefined set of game data to identify a game having the one or more game symbols; and
performing a verification operation to verify that the game is available on the cabinet type.

9. The method of claim 8, wherein determining the cabinet type comprises:
applying at least a portion of the image data comprising the cabinet region to a cabinet detection engine.

10. The method of claim 9, further comprising:
determining that the image data satisfies detection parameters for determining the cabinet type, wherein the detection parameters comprise a plurality of cabinet-related characteristics in the image data; and
applying the at least a portion of the image data comprising the cabinet region to the cabinet detection engine in response to the image data satisfying the detection parameters.

11. The method of claim 10, wherein the plurality of cabinet-related characteristics are selected from a group consisting of: cabinet angle, cabinet size, and cabinet frame count.

12. The method of claim 10, wherein the cabinet detection engine comprises a model trained on schematic data for a plurality of gaming cabinets.

13. The method of claim 8, wherein the matching operation is performed by a game detection model trained to identify the game based on the one or more symbols, and wherein the game detection model is trained to identify at least one selected from a group consisting of game-specific symbols, game family-specific symbols, and common symbols.

14. The method of claim 8, further comprising:
obtaining game information for the identified game; and
presenting the game information on a display.

15. A system comprising:
one or more cameras;
one or more processors; and
one or more computer readable media comprising computer readable code executable by the one or more processors to:
capture image data of an environment;
identify a cabinet region in the image data;
predict one or more geometric characteristics of a cabinet in the cabinet region from the image data;
determine a cabinet type for the cabinet based on the one or more geometric characteristics and a predefined set of geometric characteristics for a plurality of cabinet types;
detect a reel region in the cabinet region of the image data;
identify one or more game symbols in the reel region; and
perform a matching operation in a predefined set of game data to identify a game having the one or more game symbols; and
perform a verification operation to verify that the game is available on the cabinet type.

16. The system of claim 15, wherein the computer readable code to determine the cabinet type comprises computer readable code to:
apply at least a portion of the image data comprising the cabinet region to a cabinet detection engine.

17. The system of claim 16, further comprising computer readable code to:
determine that the image data satisfies detection parameters for determining the cabinet type, wherein the detection parameters comprise a plurality of cabinet-related characteristics in the image data; and
apply the at least a portion of the image data comprising the cabinet region to the cabinet detection engine in response to the image data satisfying the detection parameters.

18. The system of claim 17, wherein the plurality of cabinet-related characteristics are selected from a group consisting of: cabinet angle, cabinet size, and cabinet frame count.

19. The system of claim 17, wherein the cabinet detection engine comprises a model trained on schematic data for a plurality of gaming cabinets.

20. The system of claim 15, further comprising:
one or more display devices; and
computer readable code to:
obtain game information for the identified game, and
present the game information on a display.
